(19) United States
(12) Patent Application Publication
(10) Pub. No.: US 2019/0294875 A1
(43) Pub. Date: Sep. 26, 2019

(54) METHOD AND SYSTEM FOR MIXING OF MATCHED SIGNALS

(71) Applicant: DROR DOV AYALON, New York, NY (US)

(72) Inventor: Dror Dov Ayalon, New York, NY (US)

(21) Appl. No.: 16/252,721

(22) Filed: Jan. 21, 2019

Related U.S. Application Data
(60) Provisional application No. 62/647,766, filed on Mar. 25, 2018.

(51) Int. Cl. G06K 9/00; G10L 19/008

(52) U.S. Cl. CPC G06K 9/00563; G10L 19/008; G06K 9/00557

(57) ABSTRACT

A method and system are provided for mixing of signals that, the method including the steps of receiving, by a processor, a first signal with a start point and an end point; playing, by the processor, the first signal in a looped manner; mixing, by the processor, a recorded second signal with a start point and an end point, over the first signal to produce a mixed signal wherein if; the second signal is shorter in length as compared to the first signal and also completely overlaps the first signal, the mixed signal is generated by; identifying a start time of second signal over play timeline of the first signal; laying the second signal over the first signal at the identified start time; if the second signal is shorter in length as compared to the first signal and also partially overlaps the first signal, the mixed signal is generated by slicing the second signal from the end point of the first signal to generate a pre end-time segment and a post end-time segment of the second signal; adding the post end-time segment of the second signal to a start point of the first signal; and if the second signal is longer in length as compared to the first signal and also partially overlaps the first signal, the mixed signal is generated by; repeating the first signal entirely through the length of the second signal.

### CROSS-REFERENCE TO RELATED APPLICATIONS AND PRIORITY

The present application claims priority from U.S. Provisional Patent Application No. 62/647,766 filed on Mar. 25, 2018, incorporated herein as a reference.

### TECHNICAL FIELD

The present invention relates generally to identification of matching signals and more particularly to identification, matching and mixing of audio signals based on harmonics by identifying optimal synchronization points.

### BACKGROUND

Rhythm in music is formed by organization of music pieces together related to time. Whereas, rhythm may also be organized in beats and tempo. For a given music piece tempos may vary considerably. In music, a unit of time is called as a beat. The rhythm when reoccurs often to create results in melodious series. Therefore, mixing of various music pieces are required to create perfect rhythmic songs.

Therefore, there is a need for an efficient solution to determine optimal mixing music and timings of mixing to provide an optimal mixed music.

### SUMMARY

This summary is provided to introduce concepts related to system and method for automatic data collection as further described in the detailed description. This summary is not intended to identify essential features of the claimed subject matter nor is it intended for use in determining or limiting the scope of the claimed subject matter.

In an embodiment of the invention there is provided a computer implemented method for mixing of signals comprising; receiving, by a processor, a first signal with a start point and an end point; playing, by the processor, the first signal in a looped manner; mixing, by the processor, a recorded second signal with a start point and an end point, over the first signal to produce a mixed signal wherein if; the second signal is shorter in length as compared to the first signal and also completely overlaps the first signal, the mixed signal is generated by; identifying a start time of second signal over play timeline of the first signal; laying the second signal over the first signal at the identified start time; if the second signal is shorter in length as compared to the first signal and also partially overlaps the first signal, the mixed signal is generated by slicing the second signal from the end point of the first signal to generate a pre end-time segment and a post end-time segment of the second signal; adding the post end-time segment of the second signal to a start point of the first signal; and if the second signal is longer in length as compared to the first signal and also partially overlaps the first signal, the mixed signal is generated by; repeating the first signal entirely through the length of the second signal.

In another embodiment of the invention, there is provided a system for for mixing of signals, the system including; a processor configured to perform the steps of; receiving, by a processor, a first signal with a start point and an end point; playing, by the processor, the first signal in a looped manner; mixing, by the processor, a recorded second signal with a start point and an end point, over the first signal to produce a mixed signal wherein if; the second signal is shorter in length as compared to the first signal and also completely overlaps the first signal, the mixed signal is generated by; identifying a start time of second signal over play timeline of the first signal; laying the second signal over the first signal at the identified start time; if the second signal is shorter in length as compared to the first signal and also partially overlaps the first signal, the mixed signal is generated by slicing the second signal from the end point of the first signal to generate a pre end-time segment and a post end-time segment of the second signal; adding the post end-time segment of the second signal to a start point of the first signal; and if the second signal is longer in length as compared to the first signal and also partially overlaps the first signal, the mixed signal is generated by; repeating the first signal entirely through the length of the second signal.

In yet another embodiment of the invention, there is provided a non-transitory computer-readable storage medium for mixing of signals, when executed by a computing device, cause the computing device to perform method steps that includes the steps of receiving, by a processor, a first signal with a start point and an end point; playing, by the processor, the first signal in a looped manner; mixing, by the processor, a recorded second signal with a start point and an end point, over the first signal to produce a mixed signal wherein if; the second signal is shorter in length as compared to the first signal and also completely overlaps the first signal, the mixed signal is generated by; identifying a start time of second signal over play timeline of the first signal; laying the second signal over the first signal at the identified start time; if the second signal is shorter in length as compared to the first signal and also partially overlaps the first signal, the mixed signal is generated by slicing the second signal from the end point of the first signal to generate a pre end-time segment and a post end-time segment of the second signal; adding the post end-time segment of the second signal to a start point of the first signal; and if the second signal is longer in length as compared to the first signal and also partially overlaps the first signal, the mixed signal is generated by; repeating the first signal entirely through the length of the second signal.

Other and further aspects and features of the disclosure will be evident from reading the following detailed description of the embodiments, which are intended to illustrate, not limit, the present disclosure

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 illustrates block diagram of a general environment for functioning of the invention, in accordance with an embodiment of the present disclosure;

FIG. 2 illustrates block diagram of a processor and its various components, in accordance with an embodiment of the present disclosure;

FIG. 3, illustrates a flow chart of a method to identify matching audio signals, in accordance with an embodiment of the present disclosure.

FIG. 4 illustrates a table utilized for identifying dominant pitch class, in accordance with an exemplary embodiment of the present disclosure;

FIG. 5 illustrates a flow chart of a method to determine optimal sync point, in accordance with an exemplary embodiment of the present disclosure;

FIG. 6 illustrates a flow chart of a method of sliding window to determine an optimal sync point, in accordance with an exemplary embodiment of the present disclosure;

FIG. 7 illustrates a flow chart of a method of mixing audio signals, in accordance with an exemplary embodiment of the present disclosure;

FIG. 8 is a block diagram of an exemplary computer system, in accordance with an aspect of the embodiments;

### DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

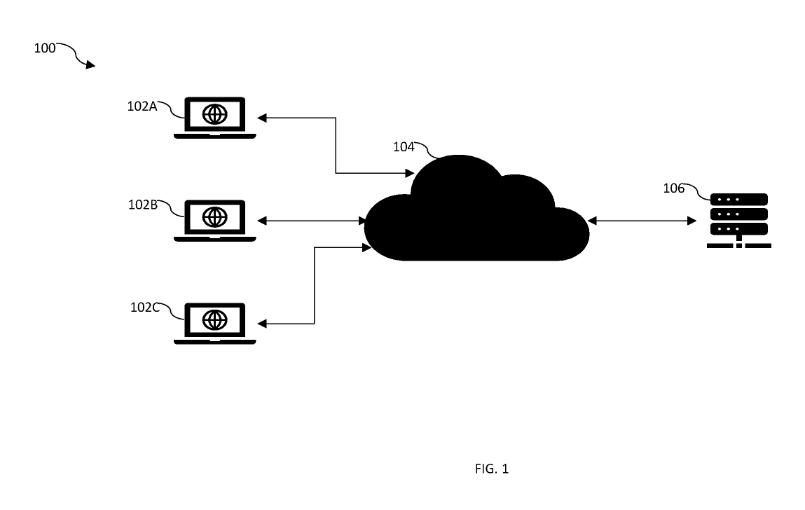

Now referring to FIG. 1, a block diagram depicting an environment 100 for function of the invention, in accordance with a version of the invention. The environment 100 may include multiple user devices 102A-C (collectively referred as user device 102). The user device 102 can be any one of a smartphone, a tablet computer, a portable gaming console, a laptop computer, or a desktop computer etc. Each of the user device 102 may be connected to a server 106 through a network 104. The network 104 may be a wired or a wireless network.

In case network 104 is a wired network, it may be anyone of a Local area network (LAN), Wide area network (WAN), or a Metropolitan area network (MAN), etc.

In case network 104 is a wireless network, it may be anyone of a wireless LAN, mobile network, satellite network, Bluetooth network, or any other suitable wireless network.

Each of the user device 102 may be connected to each other through the server 106. Also, it is not necessary that all the connected user device 102 may be connected through a single server. The server 106 may include a processor 200 (to be described in detail later). The server 106 may also be connected to a memory (not shown in figure). Memory may be a remote or a locally placed memory. The memory may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory may include modules and data. The modules include routines, programs, objects, components, data structures, etc., which perform particular tasks or implement particular abstract data types. The data, amongst other things, serves as a repository for storing data processed, received, and generated by one or more of the modules.

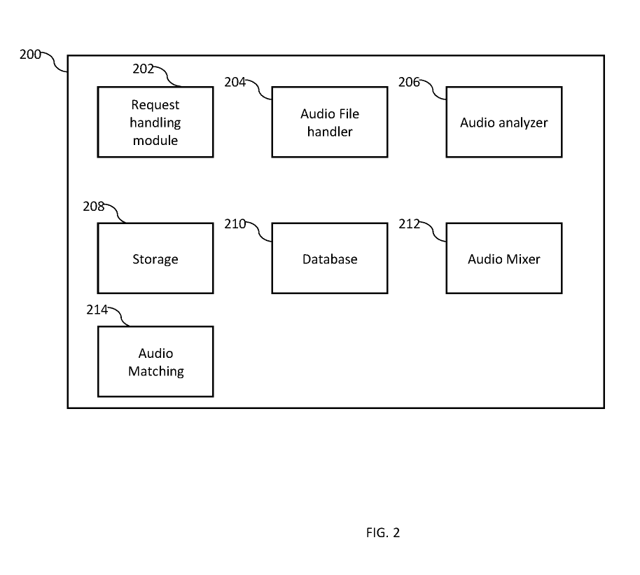

Now referring to FIG. 2, a block diagram of the processor 200 within the server, in accordance with an embodiment of the present disclosure. The processor 200 includes a request handling module 202, an audio file handler 204, an audio analyzer 206, a storage 208, a database 210, an audio mixer 212, and an audio matching module 214.

The modules may further include modules that supplement applications on the processor 200, for example, modules of an operating system. Further, the modules can be implemented in hardware, instructions executed by a processing unit, or by a combination thereof.

The request handling module 202 is configured to receive inputs of a user like a raw audio signal etc. from the user device 102. The request handling module 202 may further convert the received inputs into a format understandable to the processor 200. The request handling module is further connected to the audio file handler 204. The audio file handler 204 stores audio files temporarily and forwards the same to the audio analyzer 206. Simultaneously, the audio file analyzer 202 forwards the audio files received to storage 208 for storage. The audio analyzer 206 is configured to analyze the audio signal. Analysis of audio signals includes analysis of harmonics of the audios etc. Details of the modules will be discussed later in description.

The audio analyzer 206 forwards the analysis to the database 210 and the storage 208 simultaneously. Further, the audio analyzer 206 also forwards the audio signals after analysis to the audio mixer 212. The audio mixer 212 is configured to mix audio signals with each other.

Further, the audio matching module 214 is configured to identify audio signals matching to the other audio signals based on the analysis that may be accessed by the audio matching module 214 from the database 210.

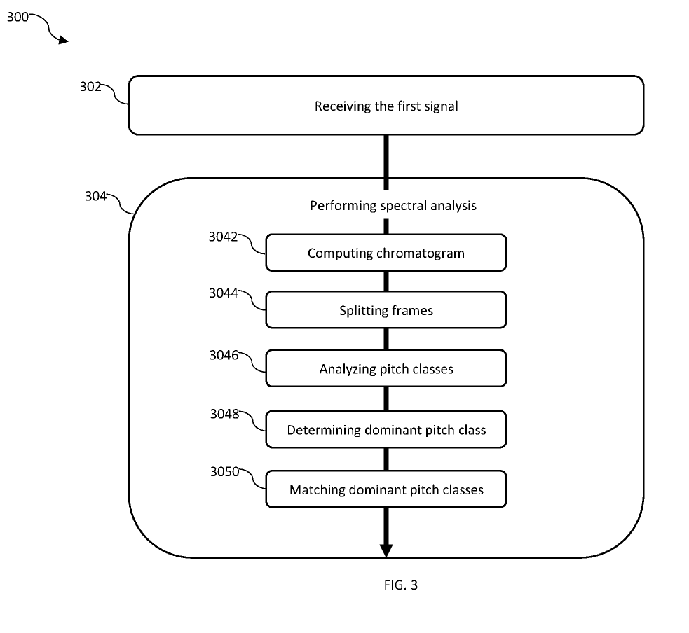

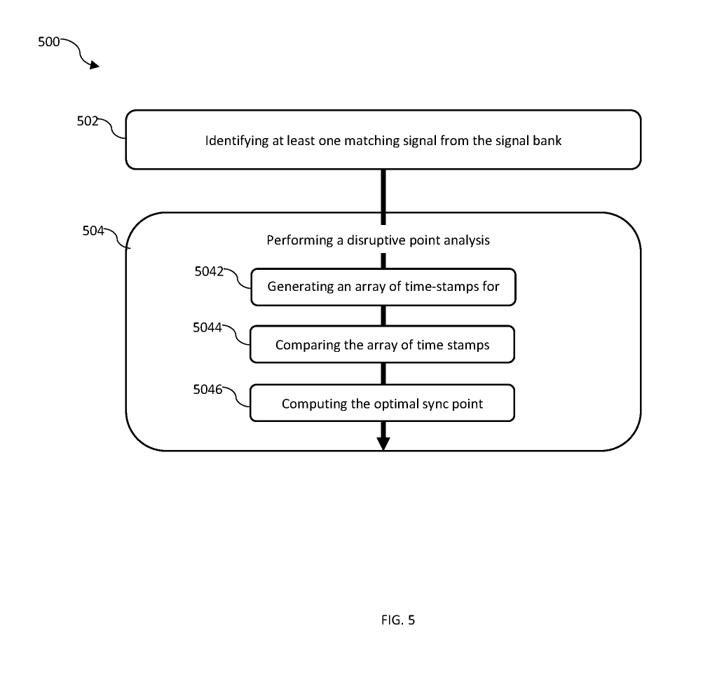

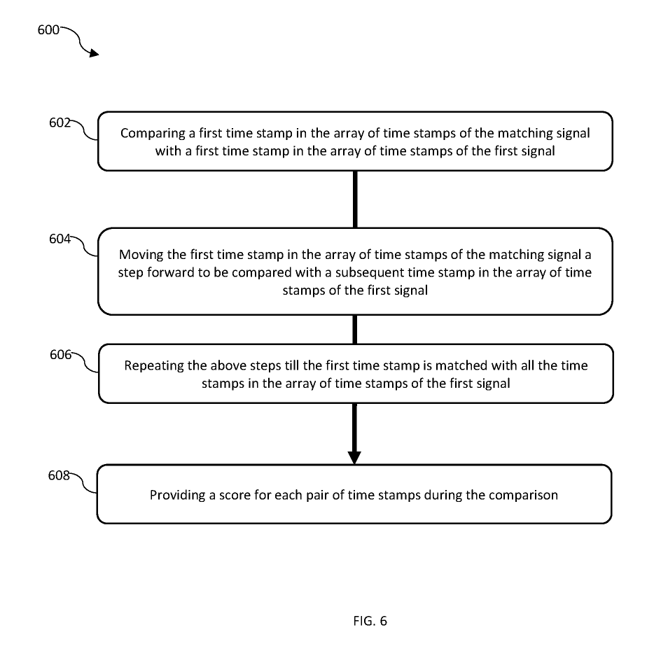

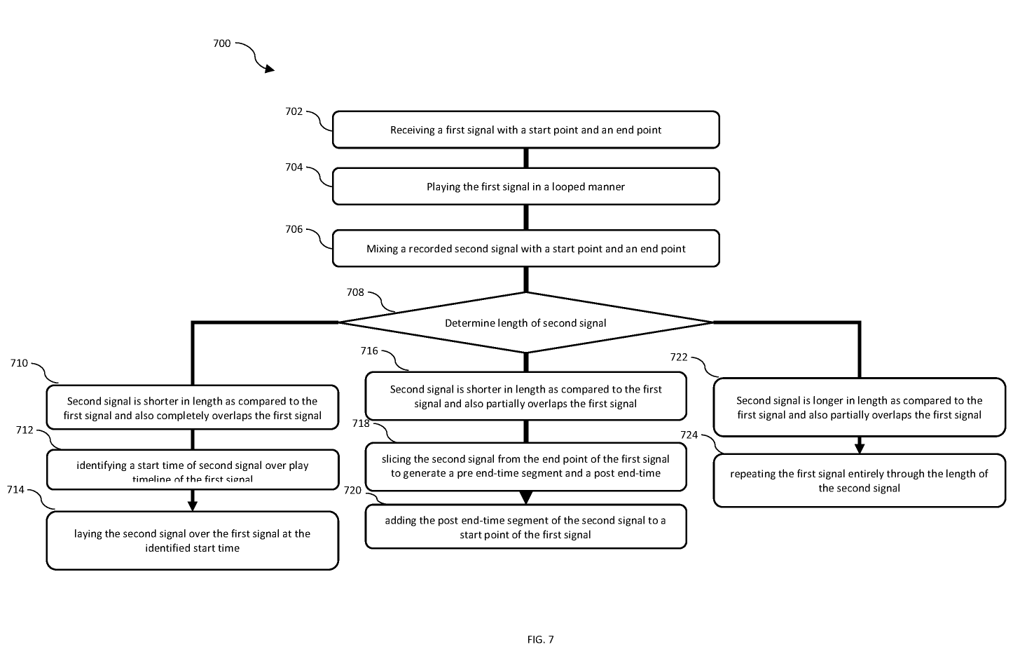

Details of the interaction of each of the modules, of the processor 200, will be described in detail while describing FIG. 3, FIG. 5, FIG. 6, and FIG. 7.

Now referring to FIG. 3, illustrating a flow chart of a method 300 to identify matching audio signals, in accordance with an embodiment of the present disclosure. The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above described system and/or the apparatus and/or any electronic device (not shown).

At step 302, the processor 200 receives a first signal also termed as a first audio signal, through the request handling module. At this step, the processor may also receive instructions from the user as to what needs to be performed. For this method 300, the instruction received may be to identify a matching signal to the first audio signal. At step 304, a spectral analysis of the first audio signal is performed by the audio analyzer 206. It is to be noted that a simultaneous spectral analysis is also performed on a bank of signals stored in the storage 208 of the processor 200 or a post analysis results of each of the signals within the signal bank is stored in the database 210 that may be accessed by the audio analyzer 206 during the identification method 300. The step 304, includes various sub steps. At first sub step that is at step 3042, a chromatogram of the first audio signal is computed consisting of a plurality of frames. The chromatogram may be generated using any well-known algorithm like short-time Fourier transform (STFT). STFT is a Fourier-related transform used to determine a sinusoidal frequency and phase content of local sections of a signal that changes overtime. STFT splits a longer time signal to shorter segments of equal length. Then the Fourier transform separately on each of the shorter segments. This generates a Fourier spectrum for each of the shorter segments. This spectrum may then be plotted in a graph as a function of time.

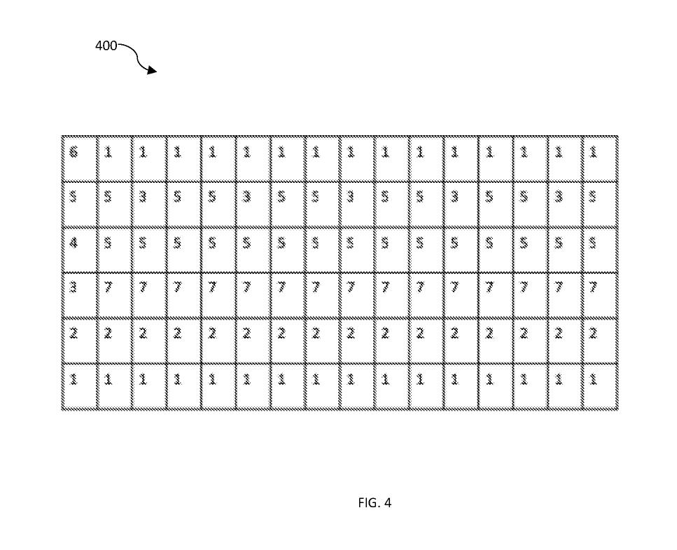

At step 3044, each of the plurality of chromatogram frames is further split into a plurality of pitch classes. FIG. 4 illustrates a sample table 400 wherein each frame is split into 6 pitch classes over 15 STFT. Further at step 3046, each of the pitch class of the frame is analyzed.

At step 3048, a dominant pitch class from the plurality of pitch classes analyzed is determined. The dominant pitch class has the highest frequency magnitude. Hence, this step results in a dominant pitch class per frame over a selected time. For example, the most dominant pitch class from the table 400 (form FIG. 4) is the 5^{th} class with the following STFT:

| | | | | | | | | | | | | | | |
|---|---|---|---|---|---|---|---|---|---|---|---|---|---|---|
| 5 | 3 | 5 | 5 | 3 | 5 | 5 | 3 | 5 | 5 | 3 | 5 | 5 | 3 | 5 |

The step 3048 counts the number of times each pitch class is the most dominant pitch class over time (the number of times each pitch class appears in the result of the last step). This step defines the outcome of the spectral analysis algorithm—The most dominant note is the note that represents the pitch class that is most dominant over all frames (over time).

For exemplary purpose the table below shows computation of the dominant pitch and class based on table 400:

Pitch Class

| | 3 | 5 |
|---|---|---|
| Most dominant on # number of frames | 5 | 10 |

At step 3050, after determining the most dominant notes of the first audio signals, comparison is done between the dominant notes of the audio signals within the signal bank. The signals selected for matching are selected if their dominant note is in harmonic interval with the with the dominant note of the first audio signal. The harmonic intervals may be the perfect 4^{th}, perfect 5^{th}, or a major 3^{rd}.

In an embodiment of the invention, the dominant note analysis of the signals from the signal bank may be stored in the database 210 from which the audio analyzer may fetch such analysis for comparison sake.

Now referring to FIG. 5, illustrating a flow chart of a method 500 to identifying an optimal sync point of a matching signal from the signal bank, in accordance with an embodiment of the invention. At step 502, the audio matching module 214 receives at least one identified matching signal from the signal bank to the first audio signal. At step 504, the audio matching module 214 performs a disruptive point analysis also known as a beat analysis.

Beat analysis step 504 contains multiple sub steps. At first sub step 5042, the first audio signal and signals in the bank of signals, go through a beat detection process, using recurrent neural network model. This step results in an array of time stamps, that represents the times on which a beat was detected (array of beat times). Further at step 5044, the array of time stamps are compared with each other to determine beat times similarity scores. The purpose of this step is to find not only the signal that syncs best with the first audio signal, but also the time on which mixing the first audio signal and the selected matching signal will result then a best possible mix. In order to do that, each array of beat times, that represent the beat times on the matching signal, from the signal bank is being compared with the array of beat times of the first audio signal. The comparison may be performed in a sliding window method.

Sliding window method 600 is illustrated by flow chart depicted in FIG. 6. In this method 600, at step 602, each array of beat times of the matching signal from the signal bank is being compared to every possible consecutive combination of beat times of the first audio signal. At step 602, a first time stamp in the array of time stamps of the matching signal is compared with a first time stamp in the array of time stamps of the first audio signal. Each of these comparisons (between the matching signal beat times and the first audio signal beat times) is scored. A single point is given for each pair of beats (from different signals), that are positioned away from each other by a pre-configured offset (the offset is set in number of digital audio samples. For example, offset of 440 is equivalent to ˜20 milliseconds on digital signal that was sampled at 22,050 samples per second).

At step 604, the first time stamp in the array of time stamps of the matching signal is moved a step forward to be compared with a subsequent time stamp in the array of time stamps of the first audio signal. On every step, the first beat of the sliding signal is aligned to the next beat of the first audio signal. In a case where the sliding array of beat times goes beyond the end of the first audio signal beat times, the non-overlapping beats will be added to the beginning of the first audio signal.

Further at step 606, the above steps are repeated till the first time stamp is matched with all the time stamps in the array of time stamps of the first audio signal. Further, at step 608, a score for each pair of time stamps during the comparison is provided. Returning back to FIG. 5 for the method 500, at step 5044, the array of time stamps generated from the sliding window method 600 are compared. The sliding signal's final score is equal to the highest score of all comparisons, over the total number of beats detected originally on this signal. Also, an optimal sync point is saved at step 5046. This sync point, defined in digital audio samples, is calculated by taking the beat time on which the similarity score between the first audio signal beat times and the sliding window beat times was the highest, and reducing the number of samples that leads to the first beat on the sliding window beat times. In a case where there is more than a single sync point with the highest similarity score, a random one is selected. The signals on the signal bank are being ordered based on their similarly score. In order to allow some unexpected results, the top 6-10 results may be picked up. Out of this top results, a random signal is selected. Based on the sync point (from matching signals) and the different lengths of the signals, the selected matching signal and the first audio signal are being mixed together (details to be discussed in conjunction with FIG. 7).

Now referring to FIG. 7, illustrating a flow chart of a method 700, for mixing audio signals, in accordance with an embodiment of the invention. At step 702, the request handling module 202 receives the first audio signal and a request to mix an audio signal on top of the first audio signal. The audio file handler 204, determines the start and the end point of the first audio signal received and forwards the information the audio analyzer 206. The audio file handler 204, also simultaneously forwards the first audio signal to the storage 208 for storing. Further, at step 704, the audio analyzer plays the first audio signal in a looped manner wherein the first audio signal is repeated.

At step 706, mixing of an identified matching signal with a determined start point and an end point is initiated. At step 708, determination of length of the matching audio signal is performed. There may be 3 options that may arise out of the determination step 708.

Option 1 depicted by step 710 wherein the matching signal is shorter in length as compared to the first signal also completely overlaps the first signal. Then at step 712, a start time of second signal over play timeline of the first audio signal is identified. Further, at step 714, the second signal is laid over the first signal at the identified start time. In this scenario, the exact loop first audio signal time is captured, on which the matching audio signal is started to be recorded. Using this timestamp, the matching audio signal is being laid (mixed) over the looping first audio signal, starting at the captured timestamp.

Option 2 depicted by step 716 wherein the matching signal is shorter in length as compared to the first signal and also partially overlaps the first signal. Then at step 718, the matching signal is sliced from the end point of the first audio signal to generate a pre end-time segment and a post end-time segment of the matching signal. Further at step 720, the post end-time segment of the matching signal is added to the start point of the first audio signal to generate the mixed signal.

The sliced part, which originally continued past the end time of the looping first audio signal, will be mixed at the beginning of the looping first audio signal. Since the looping first audio signal is being played repeatedly in a loop, this mix replicates that situation, that may be played and heard by the user while recording the mixed signal.

Option 2 depicted by step 722 wherein the matching signal is longer in length as compared to the first signal and also partially overlaps the first signal. Then at step 724, the first audio signal is repeated entirely through the length of the matching signal to generate the mixed signal.

In this scenario, in order to mix the matching signal entirely, the looping first audio signal will be repeated. The matching signal will be mixed at the recording start time. The output mix will be of a new length, because of the repeated appearance of the looping first audio signal.

Exemplary Python™ Language Coding:

Coding for mixing the matching audio signal to the looping first audio signal

```
‘‘‘
def mixer(mix_id, sound_id, sync_sample=None, timestamp=None)
    This function mixes to audio signals on a given sync point
    Parameters
    ----------
    mix_id : int
        The database ID of the playback audio signal
    sound_id : int
        The database ID of the recorded audio signal
    sync_sample : int
        The sample number that represents the optimal sync point on the
playback audio signal relevant only in case where sound_id is a matching
signal from the database, and not a new recording
    timestamp : int
        The time (in seconds) on the playback audio signal, on a which
the recording of sound_id started relevant only in case where sound_id is
a new recording
    Returns
    ----------
    new_mix_id : int
        The database ID of the newly mixed audio signal
’’’
def mixer(mix_id, sound_id, sync_sample=None, timestamp=None):
    system_sample_rate = 22050
    # Getting the data object of signal A
    mix_obj = Mix.objects.get(id=mix_id)
    # Getting the data object of signal B
    sound_obj = Sound.objects.get(id=sound_id)
    # Getting file paths (files location in the system storage)
    mix_path = mix_obj.path
    sound_path = sound_obj.path
    # Downloading signal A file
    mix_file_raw = requests.get(mix_path)
    # Loading signal A file as an AudioSegment (audio file data
structure)
    mix_seg = AudioSegment.from_file(mix_file_raw)
    # Downloading signal B file
    sound_file_raw = requests.get(sound_path)
    # Loading signal B file as an AudioSegment (audio file data
structure)
    sound_seg = AudioSegment.from_file(sound_file_raw)
    # In case where signal A's start “timestamp” is longer that signal
A's duration,
    # finding the correct time on signal A to mix signal B
    if timestamp >= mix_obj.duration:
        while ( timestamp >= mix_obj.duration ):
            timestamp = timestamp − mix_obj.duration
    # In case where starting on timestamp, signal B's duration is longer
than signal A
    if (sound_obj.duration + timestamp) > mix_obj.duration:
        # In case where duration of signal B is equal or shorter than
duration of signal A
        if mix_obj.duration >= sound_obj.duration:
            ‘‘‘
            mix ----------------------
            sound -------------
            ’’’
            # Finding where to cut signal B
            cut_point = int(mix_obj.duration*1000 −
            timestamp*1000)
            # Mixing signal A with later part of signal B
            played_togther_with_end =
mix_seg.overlay(sound_seg[:cut_point+1], position=timestamp*1000)
            # Mixing signal A with beginning part of signal B
            played_togther =
played_togther_with_end.overlay(sound_seg[cut_point:], position=0)
        # In case where duration of signal B is longer than duration of
signal A
        else:
            ‘‘‘
            mix ----------------------
            sound -------------------------------------
--
            ’’’
            # Counting the number of times signal A needs to be
repeated to fit with signal B's duration
            mix_repetitions = 1
            while ( (mix_obj.duration * mix_repetitions) <
(sound_obj.duration + timestamp) ):
                mix_repetitions+=1
            mix_seg = mix_seg * mix_repetitions
            # Mixing both signals
            played_togther = mix_seg.overlay(sound_seg,
position=timestamp*1000)
    else:
        ‘‘‘
        mix ----------------------
        sound ------------
        ’’’
        # Mixing both signals
        played_togther = mix_seg.overlay(sound_seg,
position=timestamp*1000)
    # Running audio analysis process on the new mixed audio
    data = analyze_file(y=played_togther, sr=system_sample_rate)
    # Creating a new data object instance based on the analysis results
data
    new_mix = Mix(**data)
    # Saving the new mix in the database
    new_mix.save( )
    # Returning the ID of the new mix record
    return new_mix.id
```

Coding for finding a matching signal to given first audio signal, and the optimal mix point of both signals

```
‘‘‘
def find_best_sync_point(y_mix_beats, y_sound_beats,
max_mix_sample, offset):
    This function finds the best the optimal sync point (in time and
sample) for given two audio signals
    Parameters
    ----------
    y_mix_beats : 1 x T array
        An array of integers, each one represents the sample number of a
detected beat on the playback signal
    y_sound_beats : 1 x T array
        An array of integers, each one represents the sample number of a
detected beat on the matching signal
    max_mix_sample : int
        The last sample of the playback signal (mix)
    offset : int
        The maximum acceptable distance between beats, in samples
    Returns
    ----------
    sync_sample : int
        The playback signal sample that represents the optimal sync
point for both signals
    sync_beat_number : int
        The beat number that represents the optimal sync point, on the
playback signal
    sync_beat_accuracy : float
        A value between 0 and 1
        Represents the similarity score on the optimal sync point
’’’
def find_best_sync_point(y_mix_beats, y_sound_beats,
max_mix_sample, offset):
    matches_per_round = [ ]
    for rn in range(y_mix_beats.shape[0]):
        try:
            zero_sync_samples = y_mix_beats[rn] −
            y_sound_beats[0]
            slider = y_sound_beats + (zero_sync_samples)
            for i in range(len(slider)):
                if slider[i] <= max_mix_sample:
                    continue
                else:
                    slider[i] = slider[i] − max_mix_sample
            matches = [ ]
            tested_beat_index = 0
            all_sample_beats = np.concatenate((slider, y_mix_beats))
            all_sample_beats.sort( )
            for i in range (1, all_sample_beats.shape[0]):
                if all_sample_beats[i] ==
all_sample_beats[tested_beat_index] or abs(all_sample_beats[i] −
all_sample_beats[tested_beat_index]) <= offset:
                    matches.append(all_sample_beats[i])
                    matches.append(all_sample_beats-
                    [tested_beat_index])
                    tested_beat_index+=1
                else:
                    tested_beat_index+=1
            matches_per_round.append(len(matches)/2/
            len(y_sound_beats))
        except Exception as err:
            matches_per_round.append(0)
    sync_beat_number =
np.random.choice(np.argwhere(matches_per_round ==
np.amax(matches_per_round)).reshape(−1,))
    sync_sample = y_mix_beats[sync_beat_number] −
    y_sound_beats[0]
    sync_beat_accuracy = np.max(matches_per_round)
    return sync_sample, sync_beat_number, sync_beat_accuracy
```

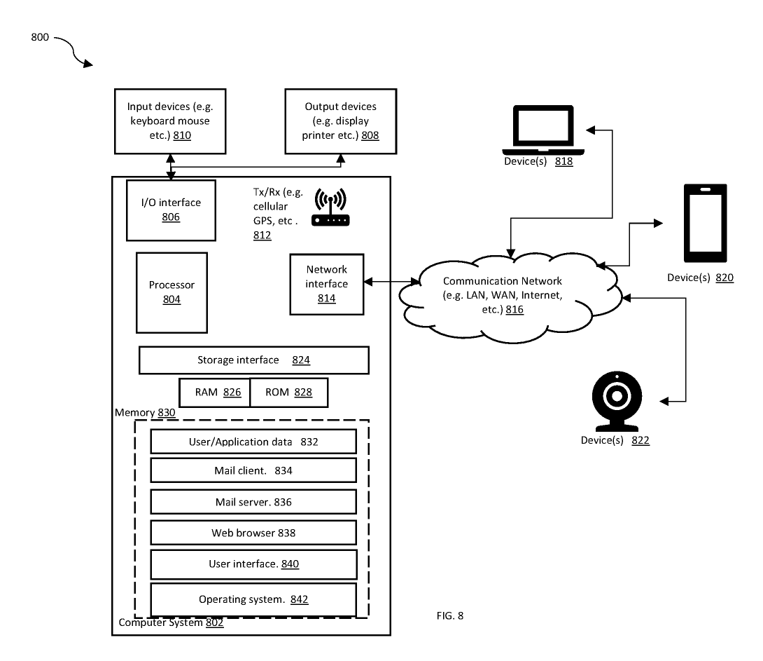

Now referring to FIG. 8, illustrating a block diagram of an exemplary computer system 802 for implementing various embodiments is disclosed. Computer system 802 may comprise a central processing unit (“CPU” or “processor”) 804. Processor 804 may comprise at least one data processor for executing program components for executing user- or system-generated requests. A user may include a person, a person using a device such as such as those included in this disclosure, or such a device itself. Processor 804 may include specialized processing units such as integrated system (bus) controllers, memory management control units, floating point units, graphics processing units, digital signal processing units, etc. Processor 704 may include a microprocessor, such as AMD Athlon, Duron or Opteron, ARM's application, embedded or secure processors, IBM PowerPC, Intel's Core, Itanium, Xeon, Celeron or other line of processors, etc. Processor 804 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 804 may be disposed in communication with one or more input/output (I/O) devices via an I/O interface 806. I/O interface 806 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 806, computer system 802 may communicate with one or more I/O devices. For example, an input device 808 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 810 may be a printer, fax machine, video display (e.g., cathode ray tube (CRT), liquid crystal display (LCD), light-emitting diode (LED), plasma, or the like), audio speaker, etc. In some embodiments, a transceiver 812 may be disposed in connection with processor 804. Transceiver 812 may facilitate various types of wireless transmission or reception. For example, transceiver 812 may include an antenna operatively connected to a transceiver chip (e.g., Texas Instruments WiLink WL1283, Broadcom BCM4760IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, processor 804 may be disposed in communication with a communication network 814 via a network interface 816. Network interface 816 may communicate with communication network 814. Network interface 816 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. Communication network 814 may include, without limitation, a direct interconnection, local area network (LAN), wide area network (WAN), wireless network (e.g., using Wireless Application Protocol), the Internet, etc. Using network interface 816 and communication network 814, computer system 802 may communicate with devices 818, 820, and 822. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, or the like. In some embodiments, the computer system 802 may itself embody one or more of these devices.

In some embodiments, processor 804 may be disposed in communication with one or more memory devices (e.g., a RAM 826, a ROM 828, etc.) via a storage interface 824. Storage interface 824 may connect to memory devices 730 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory devices 830 may store a collection of program or database components, including, without limitation, an operating system 832, a user interface application 834, a web browser 836, a mail server 838, a mail client 840, a user/application data 842 (e.g., any data variables or data records discussed in this disclosure), etc. Operating system 832 may facilitate resource management and operation of computer system 802. Examples of operating system 832 include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 834 may facilitate display, execution, interaction, manipulation, or operation of program components through textual or graphical facilities. For example, user interfaces may provide computer interaction interface elements on a display system operatively connected to computer system 802, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer system 802 may implement web browser 836 stored program component. Web browser 836 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, computer system 802 may implement mail server 838 stored program component. Mail server 838 may be an Internet mail server such as Microsoft Exchange, or the like. Mail server 838 may utilize facilities such as ASP, ActiveX, ANSI C++/C#, Microsoft .NET, CGI scripts, Java, JavaScript, PERL, PHP, Python, WebObjects, etc. Mail server 838 may utilize communication protocols such as internet message access protocol (IMAP), messaging application programming interface (MAPI), Microsoft Exchange, post office protocol (POP), simple mail transfer protocol (SMTP), or the like. In some embodiments, computer system 802 may implement mail client 840 stored program component. Mail client 840 may be a mail viewing application, such as Apple Mail, Microsoft Entourage, Microsoft Outlook, Mozilla Thunderbird, etc.

In some embodiments, computer system 802 may store user/application data 842, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above described system and/or the apparatus and/or any electronic device (not shown).

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “generating,” or “monitoring,” or “displaying,” or “tracking,” or “identifying,” “or receiving,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method of mixing of signals comprising;
Receiving, by a processor, a first signal with a start point and an end point;
Playing, by the processor, the first signal in a looped manner;
Mixing, by the processor, a recorded second signal with a start point and an end point, over the first signal to produce a mixed signal wherein if;
the second signal is shorter in length as compared to the first signal and also completely overlaps the first signal, the mixed signal is generated by;
identifying a start time of second signal over play timeline of the first signal;
laying the second signal over the first signal at the identified start time;
the second signal is shorter in length as compared to the first signal and also partially overlaps the first signal, the mixed signal is generated by
slicing the second signal from the end point of the first signal to generate a pre end-time segment and a post end-time segment of the second signal;
adding the post end-time segment of the second signal to a start point of the first signal; and
the second signal is longer in length as compared to the first signal and also partially overlaps the first signal, the mixed signal is generated by;
repeating the first signal entirely through the length of the second signal.

2. The method of claim 1, wherein the first signal is a playback audio signal.

3. The method of claim 1, wherein the second signal is a recorded audio signal.

4. The method of claim 1, wherein the second signal completely overlaps the first signal when the start point and the end point of the second signal lie within or are equal to the start point and the end point of the first signal.

5. The method of claim 1, wherein the second signal partially overlaps the first signal when the end point of the second signal lies beyond the end point of the first signal.

6. The method of claim 1, wherein length of the first signal and the second signal is measured based on start points and end points.

7. A system for mixing signals comprising;
A processor configured to perform the steps of;
Receiving a first signal with a start point and an end point;
Playing the first signal in a looped manner;
Receiving a second signal with a start point and an end point;
Mixing the second signal, over the first signal to produce a mixed signal wherein if;
the second signal is shorter in length as compared to the first signal and also completely overlaps the first signal, the mixed signal is generated by;
identifying a start time of second signal over play timeline of the first signal;
laying the second signal over the first signal at the identified start time;
the second signal is shorter in length as compared to the first signal and also partially overlaps the first signal, the mixed signal is generated by;
slicing the second signal from the end point of the first signal to generate a pre end-time segment and a post end-time segment of the second signal;
adding the post end-time segment of the second signal to a start point of the first signal; and
the second signal is longer in length as compared to the first signal and also partially overlaps the first signal, the mixed signal is generated by;
repeating the first signal entirely through the length of the second signal.

8. The system of claim 7 further comprises a storage module communicably connected to the processor to store the mixed signal produced.

9. The system of claim 8 further comprises an output module communicably connected to the processor for delivering the mixed signal to a user.

10. The system of claim 8 further includes an input module communicably connected to the processor for receiving inputs from the user.

11. The system of claim 9, wherein the output module is anyone of an audio module, a visual module, or an audio-visual module.

12. The system of claim 10, wherein the input module is an internet browser.

13. The system of claim 8, wherein the storage module is either a locally placed database or a remotely placed database.

14. The system of claim 7, wherein the first signal is a playback audio signal.

15. The system of claim 7, wherein the second signal is a recorded audio signal.

16. The system of claim 7, wherein the pre end-time segment has an end point coinciding with the end point of the first signal.

17. The system of claim 7, wherein the post-end time segment has a starting point coinciding with starting point of the first signal.

18. The system of claim 7, wherein a gap in between a start point of the pre end-time segment and an end point post end-time is filled by a part of the first signal.

19. A non-transitory computer-readable storage medium producing optimum mixing of signals, when executed by a computing device, cause the computing device to:
Receiving a first signal with a start point and an end point;
Playing the first signal in a looped manner;
Receiving a second signal with a start point and an end point;
Mixing the second signal, over the first signal to produce a mixed signal wherein;
the second signal is shorter in length as compared to the first signal and also completely overlaps the first signal, the mixed signal is generated by;
identifying a start time of second signal over play timeline of the first signal;
laying the second signal over the first signal at the identified start time;
the second signal is shorter in length as compared to the first signal and also partially overlaps the first signal, the mixed signal is generated by
slicing the second signal from the end point of the first signal to generate a pre end-time segment and a post end-time segment of the second signal;
adding the post end-time segment of the second signal to a start point of the first signal; and
the second signal is longer in length as compared to the first signal and also partially overlaps the first signal, the mixed signal is generated by;
repeating the first signal entirely through the length of the second signal.
